(19) United States
(12) Patent Application Publication
(10) Pub. No.: US 2025/0181172 A1
(43) Pub. Date: Jun. 5, 2025

(54) HUMAN-MACHINE INTERFACES VIA A SCALABLE SOFT ELECTRODE ARRAY

(71) Applicant: Georgia Tech Research Corporation, Atlanta, GA (US)

(72) Inventors: Woon-Hong Yeo, Suwanee, GA (US); Hodam Kim, Atlanta, GA (US)

(21) Appl. No.: 18/965,561

(22) Filed: Dec. 2, 2024

Related U.S. Application Data
(60) Provisional application No. 63/605,180, filed on Dec. 1, 2023.

(51) Int. Cl. G06F 3/01

(52) U.S. Cl. CPC G06F 3/017; G06F 3/015

(57) ABSTRACT

An exemplary system and method are disclosed that employs (i) a forearm-based soft wearable hand-gesture recognition system that may detect a user's hand gestures as sensed from electromyographic signals acquired at a user's forearm and (ii) an AI-based classifier to continuously determine in real-time hand gestures as HMI inputs from the sensed EMG signal. The forearm-based soft wearable electronic system may be integrated into a soft, all-in-one wearable device having a scalable electrode array and integrated wireless system that may can measure electromyograms for real-time continuous recognition of hand gestures.

### RELATED APPLICATION

This U.S. application claims priority to, and the benefit of, U.S. Provisional Patent Application No. 63/605,180, filed Dec. 1, 2023, entitled “HUMAN-MACHINE INTERFACES VIA A SCALABLE SOFT ELECTRODE ARRAY,” which is incorporated by reference herein in its entirety.

### BACKGROUND

A joystick, sometimes called a flight stick, is a human-machine-input device that employs a stick that pivots on a base and reports its angle or direction to the device it is controlling. Also known as the control column, it is the principal control device in the cockpit of many civilian and military aircraft, either as a center stick or side stick. While used in entertainment, e.g., for video game consoles, joysticks are commonly used in industrial and manufacturing applications, such as cranes, assembly lines, forestry equipment, mining trucks, and excavators.

There is a benefit to having joystick functionalities while making the handfree.

### SUMMARY

An exemplary system and method are disclosed that employs (i) a forearm-based soft wearable hand-gesture recognition system that may detect a user's hand gestures as sensed from electromyographic signals acquired at a user's forearm and (ii) an AI-based classifier to continuously determine in real-time hand gestures as HMI inputs from the sensed EMG signal. The forearm-based soft wearable electronic system may be integrated into a soft, all-in-one wearable device having a scalable electrode array and integrated wireless system that may can measure electromyograms for real-time continuous recognition of hand gestures.

The exemplary system and method may be employed at the peripheral, e.g., legs, to measure foot motion. It may be integrated with an augmented reality system to provide a comprehensive HMI system for a control application.

In an implementation, the system was observed to provide a classification for 10 gestures with an accuracy of 96.08%. Compared to the conventional rigid wearables, the multi-channel soft wearable system may offer an enhanced signal-to-noise ratio and consistency over multiple uses due to skin conformality. A study was conducted that demonstrated an AR-integrated soft wearable system for drone control. This shows the potential of the exemplary system in various applications.

The current state-of-the-art AR systems rely on hand-held controllers (e.g., joysticks) and fixed camera modules susceptible to lighting, making using current state-of-the-art AR systems limited and less user-friendly. When used in combination with the exemplary forearm-based hand recognition system, the exemplary system and method can provide intuitive, accurate, and direct control of external systems.

In an aspect, a system is disclosed comprising an electrode array assembly including an electrode array and an adhesive substrate, configured to attach to a forearm of a person, wherein the electrode array is formed by one or more flexible, conformable electrodes; and a controller having a processor; and a memory having instructions stored thereon, wherein execution of the instructions causes the processor to: receive, by the processor, measured electromyographical (EMG) signals from the electrode array assembly at the forearm while the person is making one or more hand gestures; determine, via a trained ML model, a classification value using the measured EMG signals, wherein the classification value has a correspondence to a pre-defined hand gesture among a plurality of hand gestures, wherein the trained ML model was trained using a plurality of EMG signals acquired at a set of forearms and labels corresponding to hand gestures made by a set of people; and output the classification value, wherein the classification value is subsequently employed for controls or analysis.

In some embodiments, the classification value is associated with (i) a hand gesture defined by a combination of finger and wrist positions and orientation or (ii) a hand gesture defined by one or more finger positions and configurations.

In some embodiments, the classification value is employed for a control system (e.g., aerial-based, water-based, ground-based drone, remote surgical robots, construction equipment/vehicle, graphical user interface for an operating system), wherein the control system is configured to transmit real-time video stream to an augmented reality device (e.g., AR glass).

In some embodiments, the electrode array is embedded into the adhesive substrate (e.g., wherein the one or more flexible, conformable electrodes are formed within the adhesive substrate).

In some embodiments, the controller is disposed on a surface of the adhesive substrate of the electrode array assembly.

In some embodiments, the one or more flexible, conformable electrodes are formed of (i) a serpentine-patterned structure at a first end and (ii) a terminal at a second end.

In some embodiments, each serpentine-patterned structure of the one or more flexible, conformable electrodes is formed of a first layer including a metal (e.g., copper, gold) and a second layer including a polyimide.

In some embodiments, the classification value is employed as an actuatable control output to a control system.

In some embodiments, the classification value is employed for an analysis system (e.g., for medical evaluation).

In some embodiments, the classification value is employed as a prompt input for a computer operating system.

In another aspect, a method is disclosed comprising receiving, by a processor, measured electromyographical (EMG) signals from an electrode array assembly at a forearm while a person is making one or more hand gestures; determining, via a trained ML model, a classification value using the measured EMG signals, wherein the classification value has a correspondence to a pre-defined hand gesture among a plurality of hand gestures, wherein the trained ML model was trained using a plurality of EMG signals acquired at a set of forearms and labels corresponding to hand gestures made by a set of people; and outputting the classification value, wherein the classification value is subsequently employed for controls or analysis.

In some embodiments, the electrode array assembly includes an electrode array and an adhesive substrate, configured to attach to the forearm of the person, wherein the electrode array is formed by one or more flexible, conformable electrodes.

In some embodiments, the electrode array is embedded into the adhesive substrate (e.g., wherein the one or more flexible, conformable electrodes are formed within the adhesive substrate).

In some embodiments, the one or more flexible, conformable electrodes are formed of (i) a serpentine-patterned structure at a first end and (ii) a terminal at a second end.

In some embodiments, each serpentine-patterned structure of the one or more flexible, conformable electrodes is formed of a first layer including a metal (e.g., copper, gold) and a second layer including a polyimide.

In some embodiments, the classification value is associated with (i) a hand gesture defined by a combination of finger and wrist positions and orientation or (ii) a hand gesture defined by one or more finger positions and configurations.

In some embodiments, the classification value is employed for a control system (e.g., aerial-based, water-based, ground-based drone, remote surgical robots, construction equipment/vehicle, graphical user interface for an operating system), wherein the control system is configured to transmit real-time video stream to an augmented reality device (e.g., AR glass).

In some embodiments, the classification value is employed as an actuatable control output to a control system.

In some embodiments, the classification value is employed for an analysis system (e.g., for medical evaluation).

In another aspect, a non-transitory computer-readable medium is disclosed having instructions stored thereon, wherein execution of the instructions by a processor causes the processor to receive, by the processor, measured electromyographical (EMG) signals from an electrode array assembly at a forearm while a person is making one or more hand gestures; determine, via a trained ML model, a classification value using the measured EMG signals, wherein the classification value has a correspondence to a pre-defined hand gesture among a plurality of hand gestures, wherein the trained ML model was trained using a plurality of EMG signals acquired at a set of forearms and labels corresponding to hand gestures made by a set of people; and output the classification value, wherein the classification value is subsequently employed for controls or analysis.

### BRIEF DESCRIPTION OF DRAWINGS

FIGS. 1A-1C each shows an example system configured with a stretchable EMG sensor device and a classifier (i.e., trained machine learning (ML) model) for detecting hand gestures from electromyographical (EMG) signals and providing control of external systems in accordance with an illustrative embodiment. FIG. 1A operates the EMG sensor device and the classifier on a human-machine interface. FIG. 1B operates the EMG sensor device on a human-machine interface and the classifier on a controller. FIG. 1C employs an augmented reality device.

FIG. 2A shows an example operation for the exemplary system in accordance with an illustrative embodiment.

FIG. 2B shows an example of training for the classifier of the exemplary system in accordance with an illustrative embodiment.

FIG. 3 shows an example system configured with an augmented reality (AR) device (e.g., AR glass) that recognizes hand/wrist gestures through electromyographical (EMG) signals and wirelessly controls a drone.

FIGS. 4A-4D show a fabricated sensor device of the exemplary system and a fabrication process of the sensor device. FIG. 4A shows the schematic illustrations of the sensor device, including an array of mesh electrodes, interconnectors, and a circuit. FIG. 4B shows the measured skin-electrode contact impedance of two electrode types: (1) serpentine-patterned (used in the fabricated sensor device) and (2) nonpatterned rectangular. FIG. 4C shows the fabrication process of the sensor device of the exemplary system. FIG. 4D shows the bendability, stretchability, and twistability of the fabricated sensor device.

FIGS. 5A-5P show experimental results for the different mechanical, sensor, electrical, signal processing, and software subsystems of the exemplary system. FIG. 5A shows the mechanical characterization and material properties of the exemplary system. FIG. 5B shows the measured electrical resistance of the interconnector and electrodes of the fabricated sensor device during continuous bending strain and stretching strain. FIG. 5C shows the measured moisture vapor transmission rate (MVTR) values for four adhesive substrates (e.g., 9907T+S, 9907T, 2476P, and 2480). FIG. 5D shows an experiment measuring the peeling force of the four adhesive substrates (e.g., 9907T+S, 9907T, 2476P, 2480) from the skin in both dry and wet skin conditions. FIG. 5E shows the measured peeling force, peeling energy ratio, and peeling energy values of the four adhesive substrates from the skin. FIG. 5F shows the skin condition while wearing the fabricated sensor device for 8 hours. FIG. 5G shows the fabricated sensor device and a commercial armband-type device (e.g., Myo). FIG. 5H shows a program that recorded EMG signals and presented hand gesture images. FIG. 5I shows the EMG signal values measured by the fabricated sensor device and the commercial device (e.g., Myo). FIGS. 5J and 5K show the histogram of the calculated signal-to-noise ratio (SNR) values under dry and wet skin conditions. FIG. 5L shows the representative images and corresponding EMG signals from ten hand gestures made by a subject wearing the fabricated sensor device. FIG. 5M shows the classification method and the evaluation of the classifier of the exemplary system and other state-of-the-art classifiers. FIG. 5N shows the hyperparameters of support vector machine (SVM) optimized using the grid search method for total datasets and the classification accuracy of individual datasets. FIG. 5O shows the recognition accuracy of the fabricated sensor device and the commercial device (e.g., Myo). FIG. 5P shows the performance of the exemplary system configured for wireless, real-time, continuous control of a first-person-view (FPV) drone.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

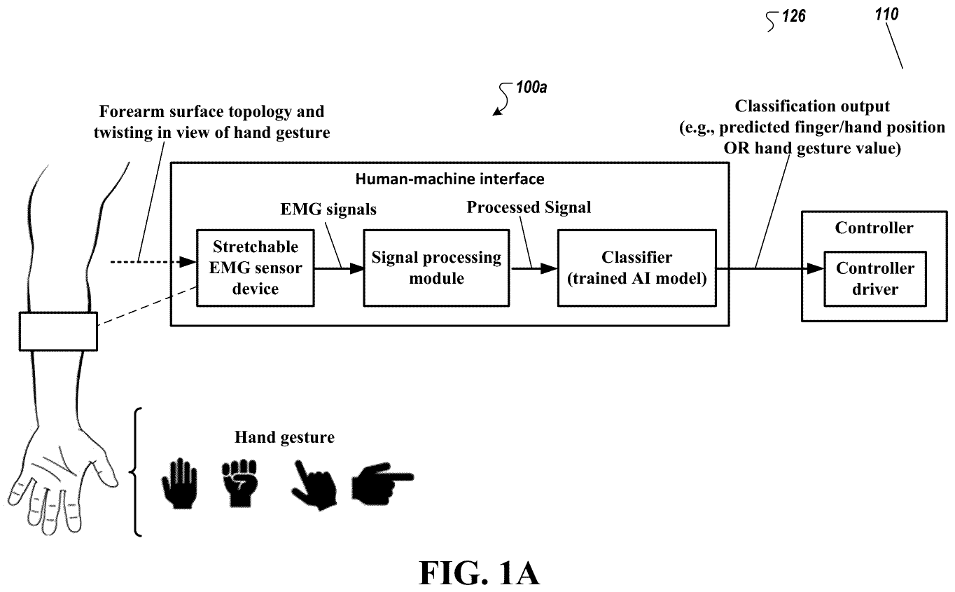

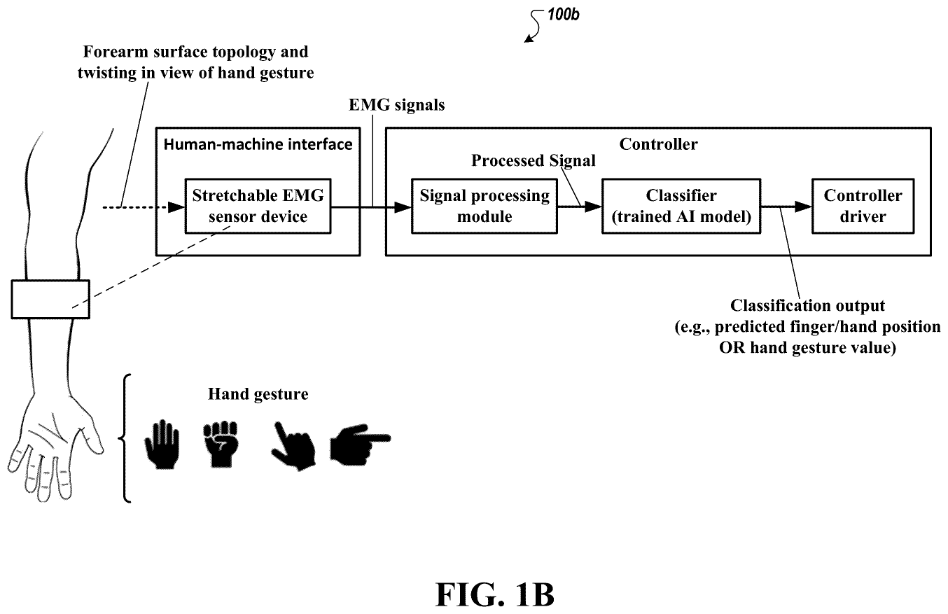

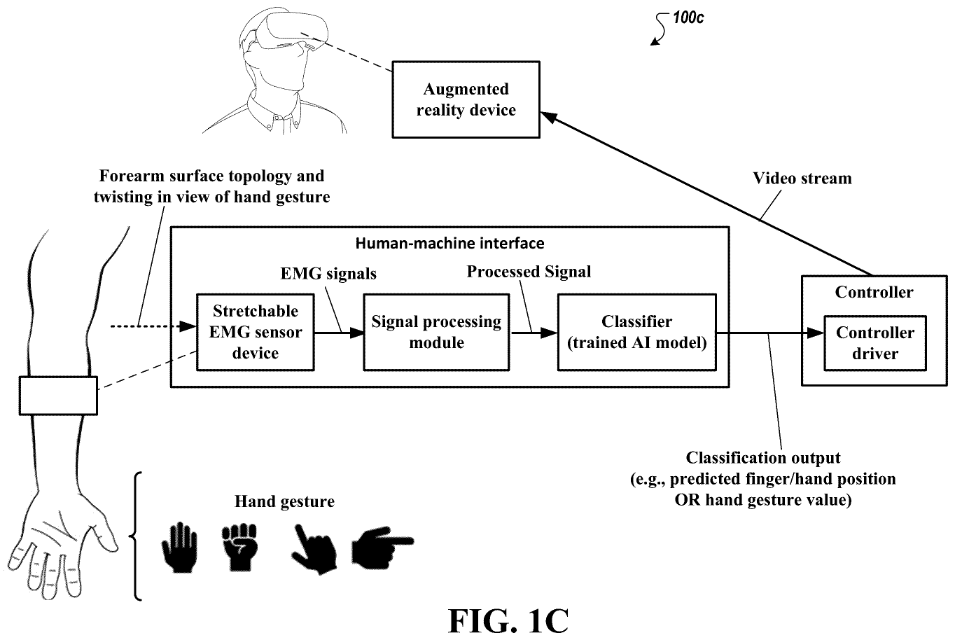

FIGS. 1A-1C each shows an example system 100 (shown as 100a, 100b, 100c) configured with a stretchable EMG sensor device and a classifier (i.e., trained ML model) for detecting hand gestures from electromyographical (EMG) signals and providing control of external systems. FIG. 1A operates the EMG sensor device and the classifier on a human-machine interface. FIG. 1B operates the EMG sensor device on a human-machine interface and the classifier on a controller. FIG. 1C employs an augmented reality device.

In the examples shown in FIGS. 1A and 1C, the systems 100a and 100c each include a human-machine interface 102, wherein the human-machine interface 102 is configured with the stretchable EMG sensor device 106 (shown as 106′), a signal processing module 110, and the classifier 114. The EMG sensor device 106, operating on the human-machine interface 102, generates measured EMG signals 108 from an electrode array assembly (not shown) at a forearm 104 while a user makes one or more hand gestures 105. The signal processing module 110, coupled with the EMG sensor device 106, receives the measured EMG signals 108 and generates processed EMG signals 112 (e.g., by performing analog-to-digital conversion on the measured EMG signals 108). The classifier 114, coupled with the signal processing module 110, determines a classification value 116 using the processed signals 112 and then outputs the classification value 116 to a controller driver 118 operating on a controller 120.

In system 100b, as shown in FIG. 1B, the signal processing module 110, the classifier 114, and the controller driver 118 operate on the controller 120. The signal processing module 110, operating on the controller 120, receives the measured EMG signals 108 and generates processed EMG signals 112. The classifier 114, coupled with the signal processing module 110, determines a classification value 116 using the processed signals 112. The classifier 114 then outputs the classification value 116 to the controller driver 118, which also operates on the controller 120.

In system 100c, as shown in FIG. 1C, the controller 120 is configured to transmit video stream 130 to an augmented reality device 132 (shown as 132′) while using the classification value 116 for controls.

In the examples shown in FIGS. 1A-1C, the classifier 114 (i.e., trained ML model) may be trained using a plurality of EMG signals acquired at a set of forearms and labels corresponding to hand gestures made by a set of people. The classification value 116 may have a correspondence to a pre-defined hand gesture among a plurality of hand gestures. The classification value 116 may be associated with (i) a hand gesture defined by a combination of finger and wrist positions and orientation or (ii) a hand gesture defined by one or more finger positions and configurations. The classification value 116 may be employed (i) as an actuatable control output to a control system, (ii) for an analysis system (e.g., for medical evaluation), or (iii) as a prompt input for a computer operating system.

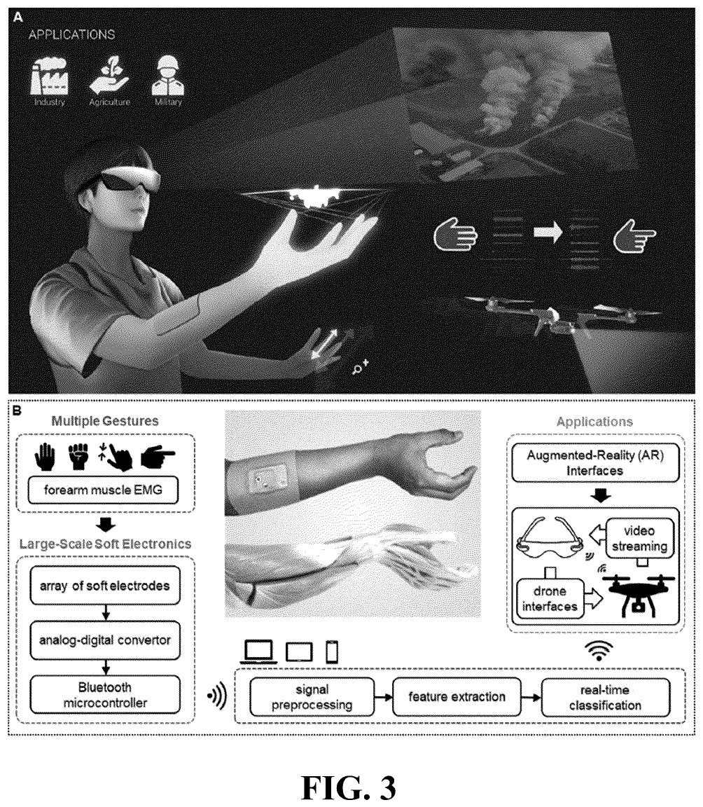

In systems 100a-100c, the electrode array assembly (not shown; see FIGS. 3, 4a-4d, 5d, 5g, 5k) may comprise an electrode array and an adhesive substrate configured to attach to the forearm of the person. The electrode array may be formed by one or more flexible, conformable electrodes. The electrode array may be embedded into the adhesive substrate (e.g., the one or more flexible, conformable electrodes are formed within the adhesive substrate). The one or more flexible, conformable electrodes may be formed of (i) a serpentine-patterned structure at a first end and (ii) a terminal at a second end. Each serpentine-patterned structure of the one or more flexible, conformable electrodes may be formed of a first layer comprising a metal (e.g., copper, gold) and a second layer comprising a polyimide.

### Example Method

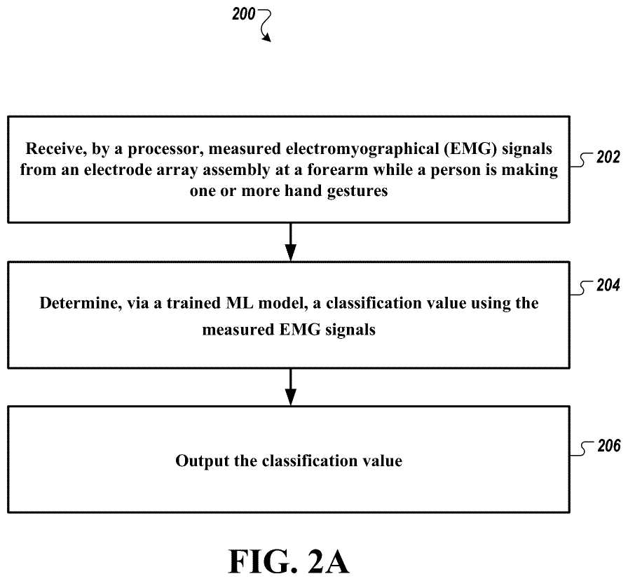

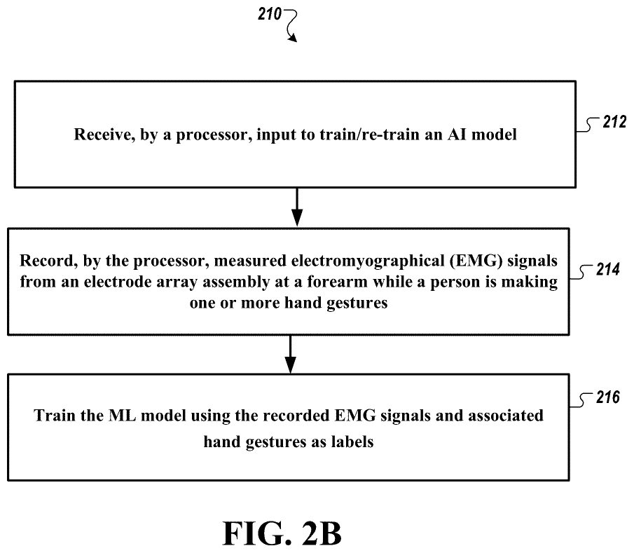

FIG. 2A shows an example operation flow 200 for the exemplary system, in accordance with an illustrative embodiment. Method 200 includes, at step 202, receiving, by a processor, measured electromyographical (EMG) signals from an electrode array assembly at a forearm while a person is making one or more hand gestures. At step 204, the exemplary system may determine, via a trained machine learning (ML) model, a classification value using the measured EMG signals. At step 206, the exemplary system may output the classification value.

In some embodiments, the electrode array assembly comprises an electrode array and an adhesive substrate, configured to attach to the forearm of the person, wherein the electrode array is formed by one or more flexible, conformable electrodes.

In some embodiments, the electrode array is embedded into the adhesive substrate.

In some embodiments, the flexible, conformable electrodes are formed of (i) a serpentine-patterned structure at a first end and (ii) a terminal at a second end.

In some embodiments, each serpentine-patterned structure of the one or more flexible, conformable electrodes is formed of a first layer comprising a metal and a second layer comprising a polyimide.

In some embodiments, the classification value is associated with (i) a hand gesture defined by a combination of finger and wrist positions and orientation or (ii) a hand gesture defined by one or more finger positions and configurations.

In some embodiments, the classification value is employed for a control system, wherein the control system is configured to transmit real-time video stream to an augmented reality device.

In some embodiments, the classification value is employed as an actuatable control output to a control system.

In some embodiments, the classification value is employed for an analysis system (e.g., for monitoring hand motion, e.g., for work monitoring/efficiency).

### Example Method of Training

FIG. 2B shows an example method 210 of training for the classifier of the exemplary system in accordance with an illustrative embodiment. Method 210 includes receiving (212) an input to initiate training or re-training an AI model. Method 210 includes recording (214), by the processor, measured electromyographical (EMG) signals from an electrode array assembly at a forearm while a person is making one or more pre-defined hand gestures. Method 210 then includes training (216) the ML model using the recorded EMG signals and associated hand gestures as labels.

The method may employ optimized gesture recognition that integrates with a Riemannian feature with a support vector machine. The training operation may employ only a 1-minute training period.

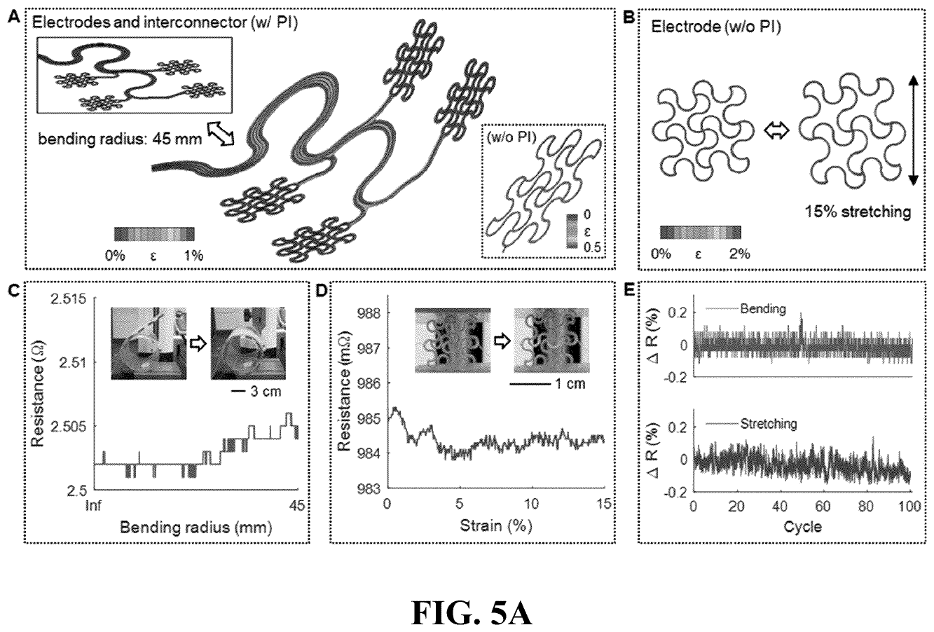

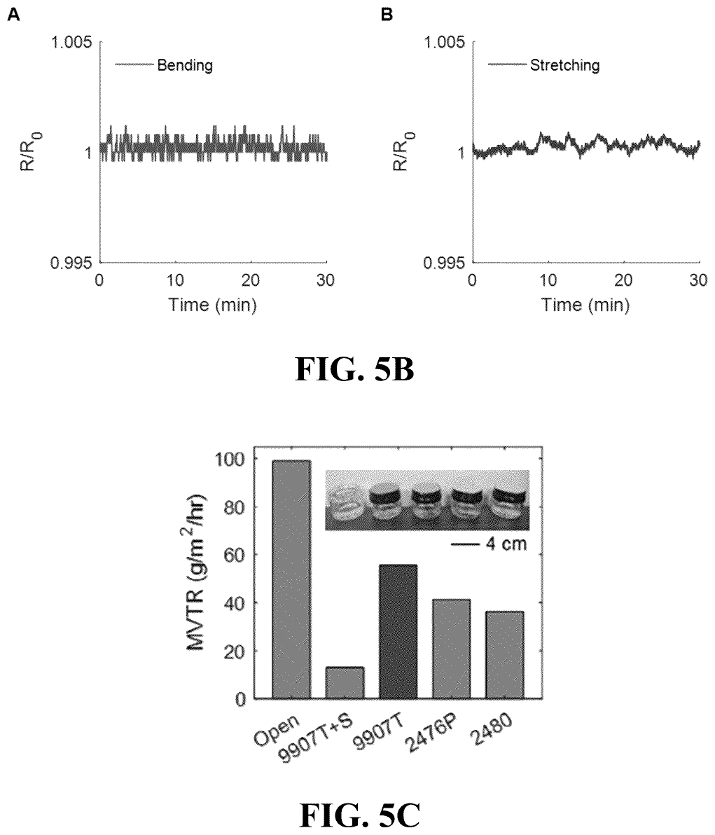

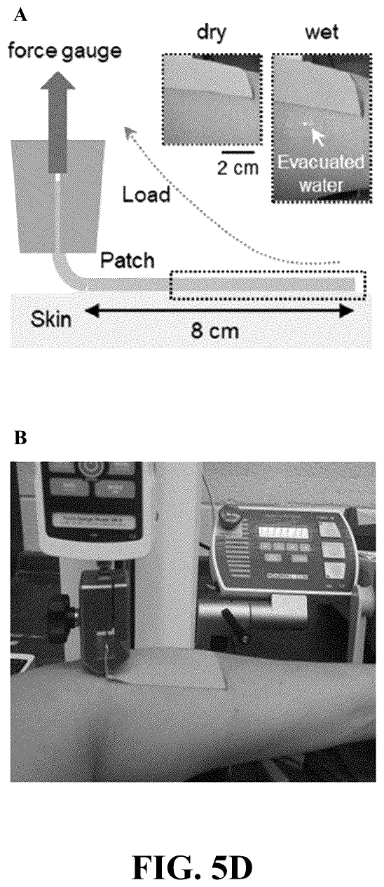

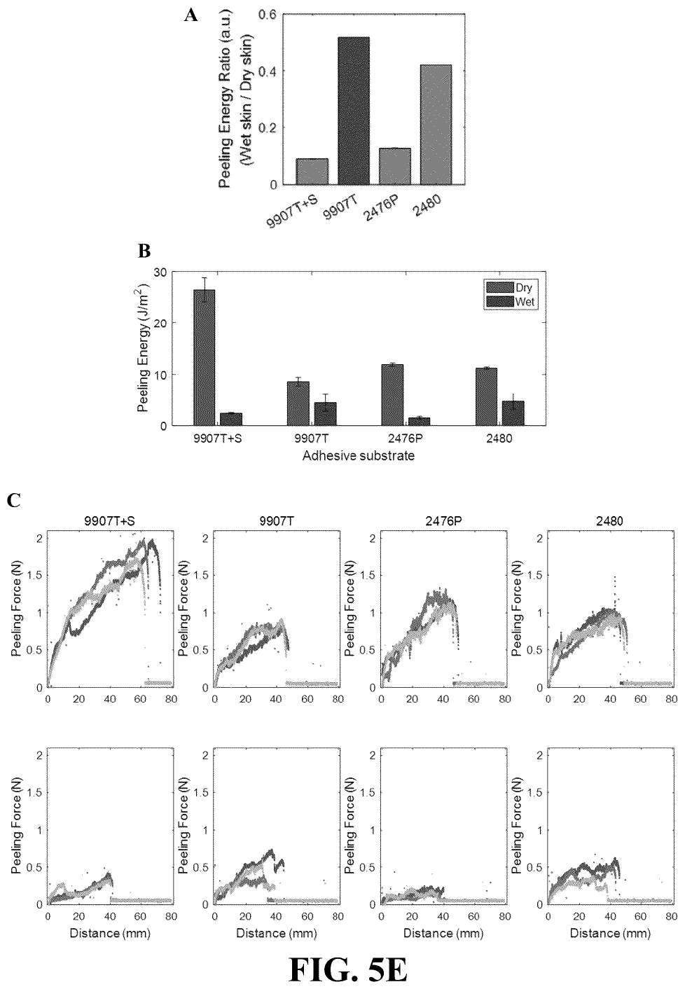

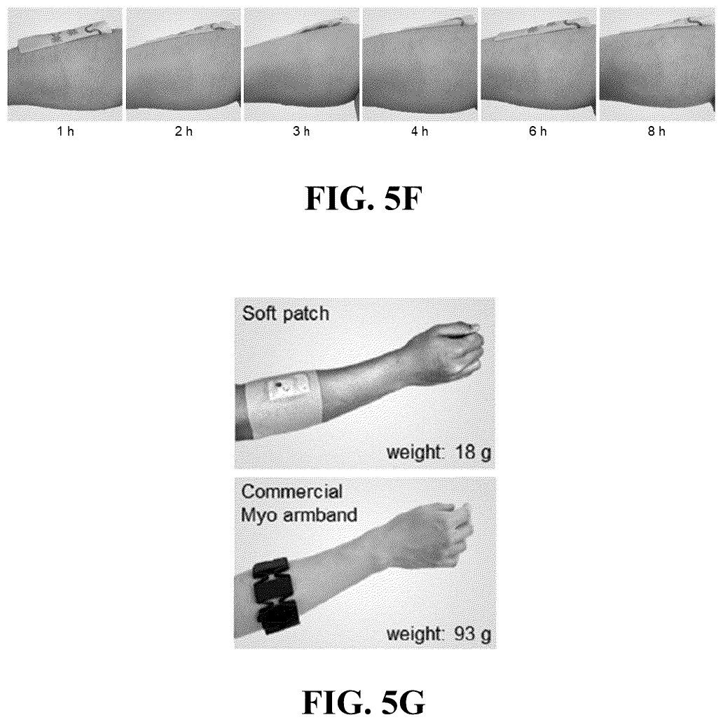

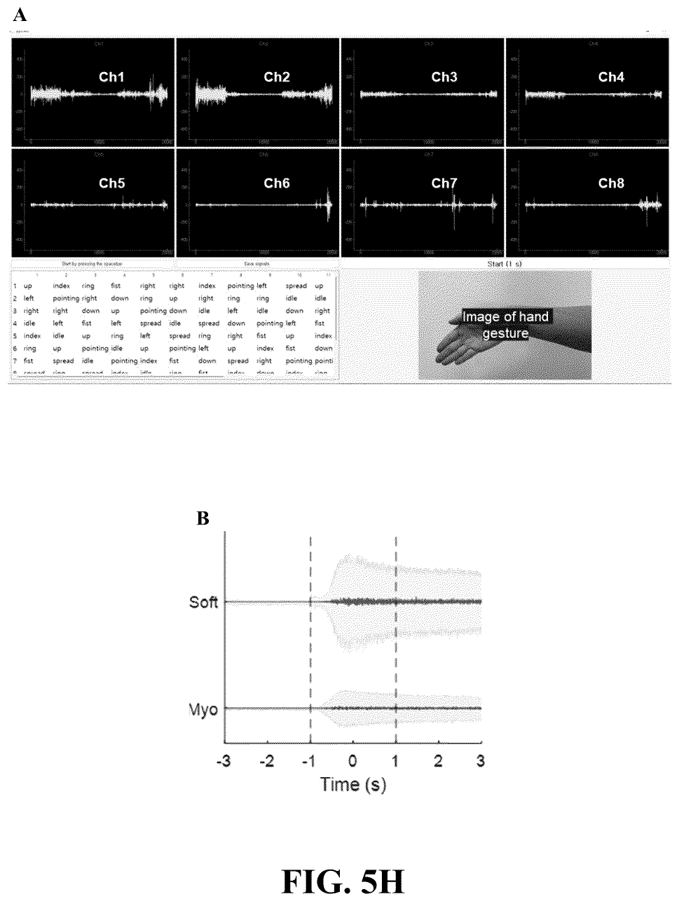

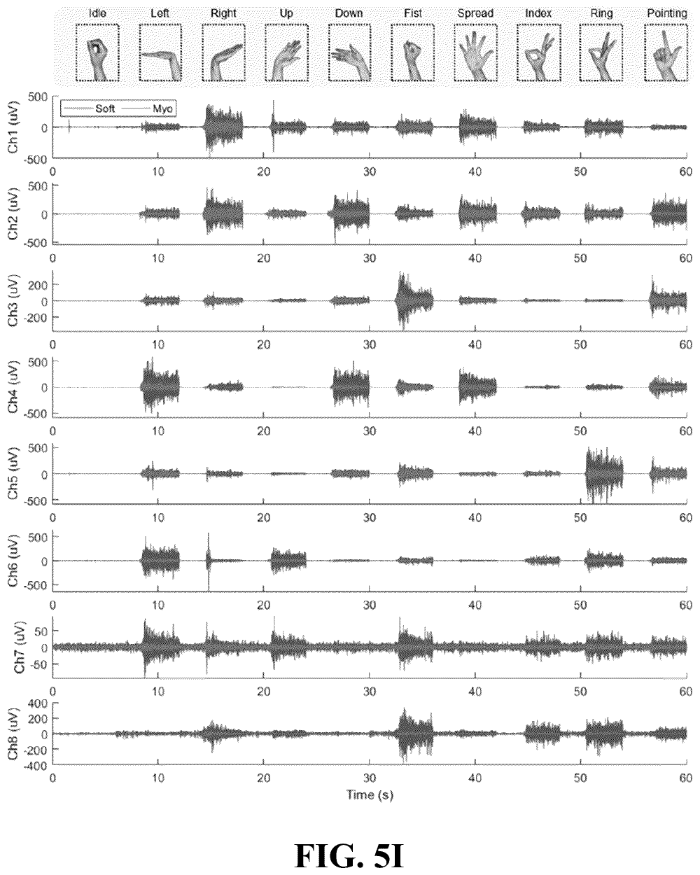

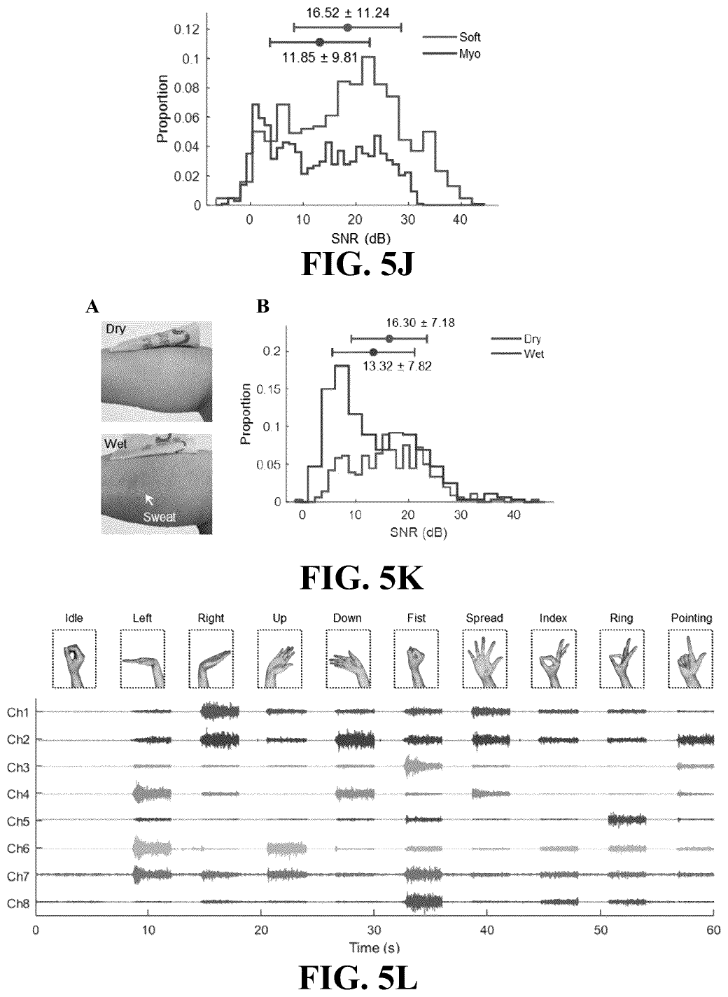

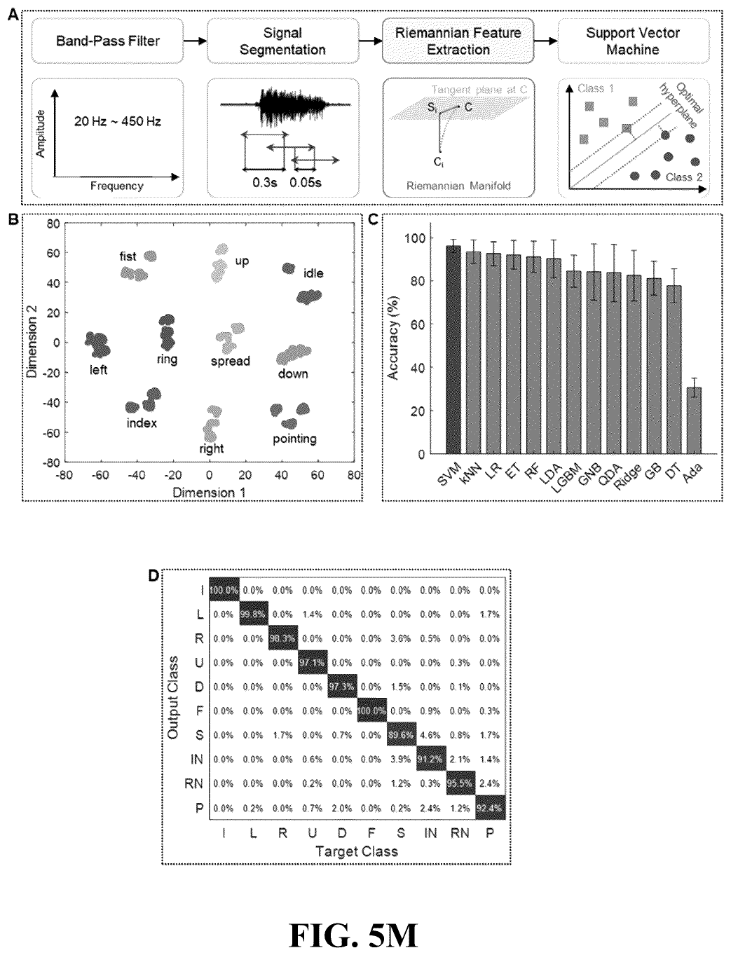

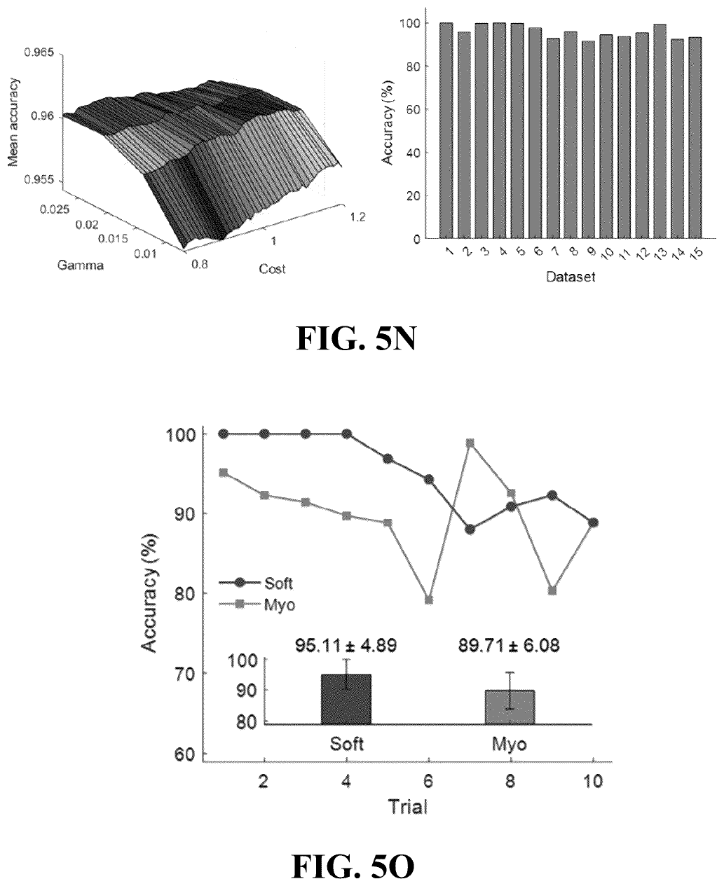

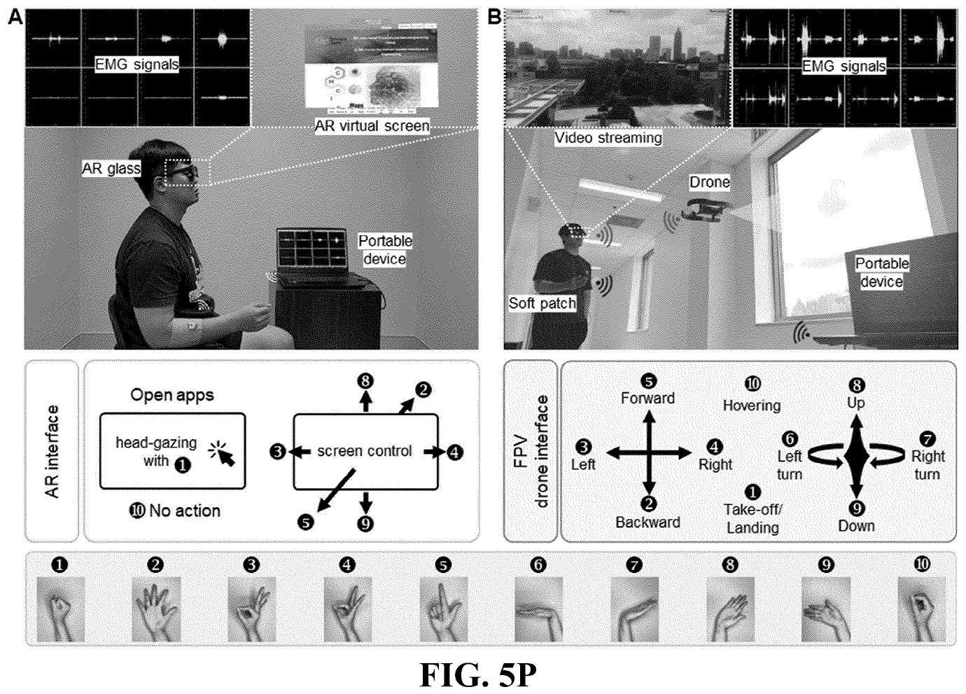

Examples of hand gestures include right, up, down, fist, spread, index, ring, pointing, e.g., as shown in relation to FIG. 5I. In some embodiments, the hand gestures include joystick motion for the left hand or right hand for left, right, up, down, up-left, up-right, down-left, and down-right. In some embodiments, the hand gestures include hand sign language.

In some embodiments, the hand gestures include a finger position as an action button that can be used in combination with a hand gesture.

Machine Learning. In addition to the machine learning features described above, the analysis system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan h, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Example Augmented-Reality-Enabled Wireless Human-Machine Interface System

FIG. 3 shows an example system configured with an augmented reality (AR) device (e.g., AR glass) that recognizes hand/wrist gestures through EMG signals and wirelessly controls a drone. In FIG. 3, subpanel (a), a user wears AR glasses and puts a stretchable EMG sensor device 304 (shown as 304′) on the user's forearm to detect EMG signals. This setup enables the control of an AR virtual screen 326 and drone actions 310 (shown as 310′) through hand and wrist gestures 312 (shown as 312′). The exemplary AR-integrated system allows users to control various virtual environments and external devices unrestrictedly in low-light conditions, recognizing specific motions through the stretchable EMG sensor device 304. Practical applications of this exemplary system span various fields, including industry [7], agriculture [8], and military [9].

FIG. 3, subpanel (b) shows the overview of external control using the exemplary system, including gesture recognition, signal conversion, wireless data transfer, data classification, AR interface, and drone interface. The gesture recognition is enabled by EMG detection 314 on the forearm, with the scalable EMG sensor device 304 having eight channels (i.e., array of soft electrodes 316). The EMG sensor device 304 includes an analog-digital converter 318 and a Bluetooth microcontroller 320, all working harmoniously for signal preprocessing 322 and ML classification 324 via a portable device (e.g., laptop, tablet, smartphone). The AR interface 326 is controlled by the measured EMG signals for real-time, wireless, continuous control (via drone interface 328) of an FPV drone with a video streaming capability 330 (shown as 330′).

### EXPERIMENTAL RESULTS AND ADDITIONAL EXAMPLES

A study was conducted to develop and evaluate the exemplary system and method for (i) detecting hand gestures using EMG signals from a stretchable EMG sensor device and (ii) operating external control and analysis systems. Specifically, the study developed AR and human-machine interfaces controlled by EMG data from a scalable sensor device. The wearable device with an array of electrodes allows for skin conformality, long-term wearability, multiple uses, and wireless data transfer for detecting various types of muscle activities with high accuracy. The sensor device showed more reliable and higher sensing performance than a commercial device. The Riemannian feature-based classification developed offered 96.08% accuracy in classifying ten hand gestures with only 1-min training. The demonstration of real-time continuous control of an FPV drone captured the capabilities of the AR-integrated SED with eight-channel EMG electrodes.

In the demonstration, a user could utilize ten gestures as virtual screen control commands for drone teleoperation. The sensor device's signal quality and classification performance can be affected by physiological characteristics, such as skin roughness, muscle mass, and fat mass on the forearm. Therefore, for the practical applications of the sensor device in the fields of industry, agriculture, and military, it would be a promising topic to investigate the influence of various physiological factors on the performance of the sensor device, enhancing its adaptability and efficiency across diverse user profiles. Furthermore, hand gesture recognition technology presented in this study can play an essential role in various applications, such as prosthetic control for amputees, surgeon control of robotic-assisted systems, and sign language recognition for deaf people. Future work would focus on adding densely packed electrodes and detecting additional motions for persistent human-machine interfaces.

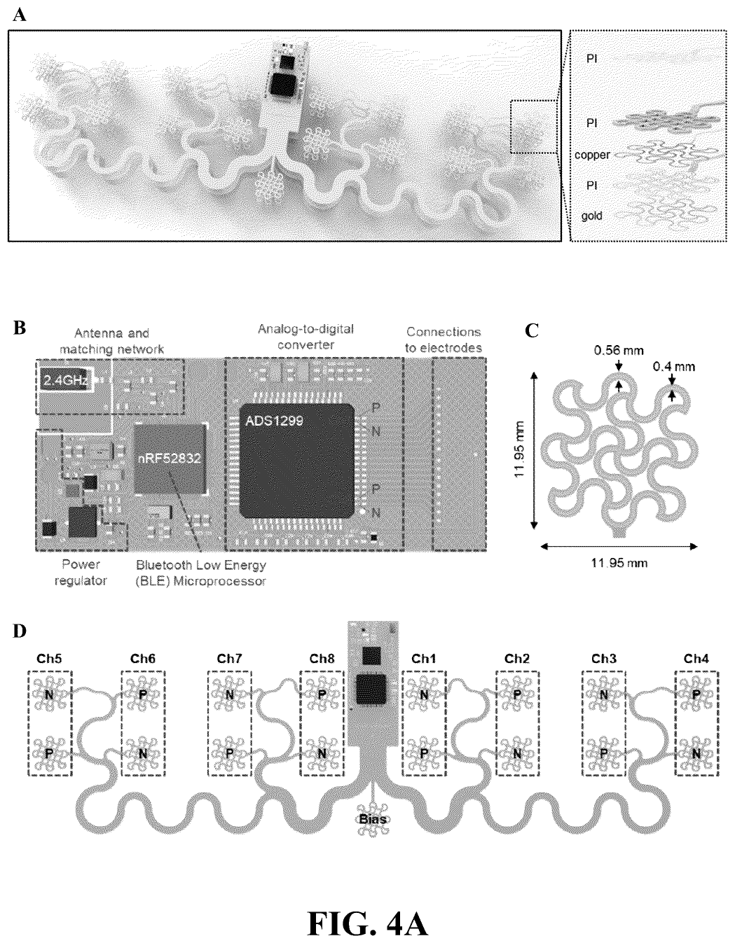

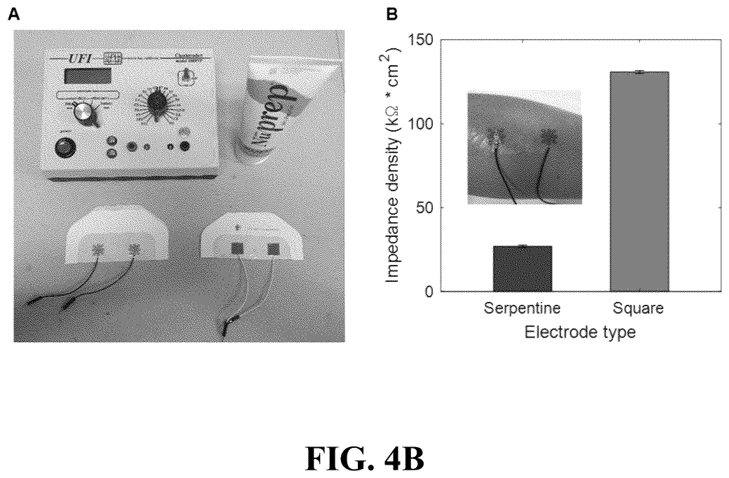

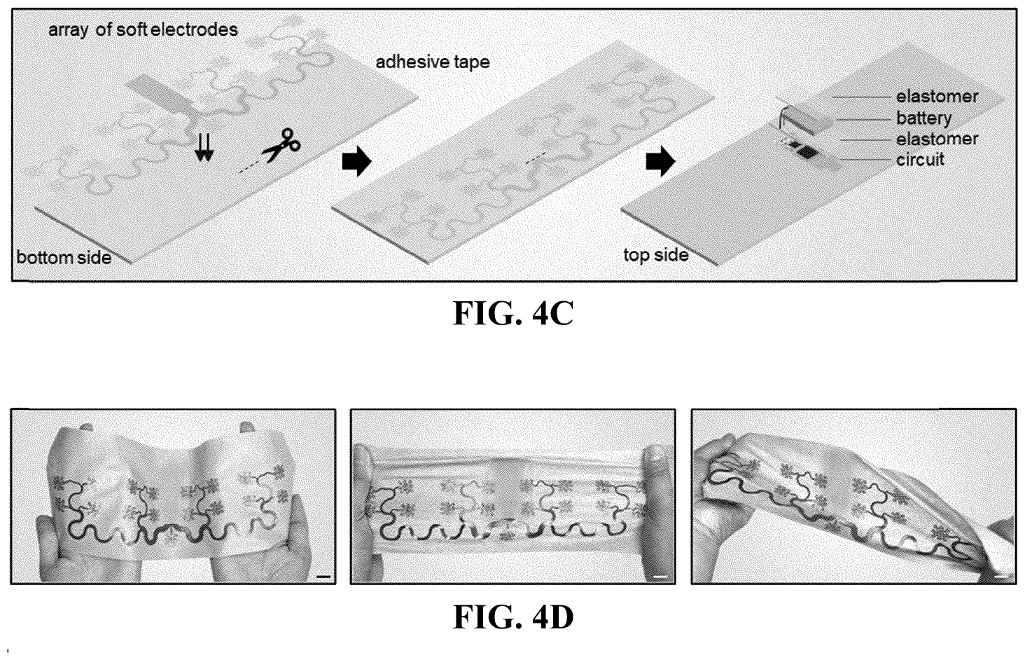

Fabricated System. The study fabricated a stretchable EMG sensor device for the exemplary system. FIGS. 4A-4D show a fabricated sensor device of the exemplary system, wherein the sensor device integrates an array of flexible electrodes, stretchable interconnectors, and a wireless circuit.

Soft electrode array. FIG. 4A shows the schematic illustrations of the sensor device 400, including an array of mesh electrodes, interconnectors, and a circuit. The provided enough flexibility to endure resistance change and stress concentration when placed on the forearm. The sensor device size was 227.26×72.26 mm with a thickness of 0.5 mm.

In FIG. 4A, subpanel (a), the sensor device 400 includes an array of 17 mesh electrodes (e.g., 402a-402r), stretchable interconnectors 404 (shown as Ch1-Ch8 in FIG. 4A, subpanel d), and a wireless circuit 406 (shown as 406′). A single electrode of the mesh was composed of multiple layers of materials (e.g., PI, copper, gold) (shown in an exploded view 408).

In FIG. 4A, subpanel (b), the wireless circuit 406′ consisted of an analog-to-digital converter 410 (ADC), microprocessor 412, antenna 414, and power regulator 416. The ADC 410 measured differential voltage from the electrodes 402a-402r and converted that into a digital signal. The microprocessor 412 read the digital signal and transmitted it to an external device through a low-power Bluetooth antenna 414 (≈2.4 GHz). Serpentine-patterned electrodes 402a-402r, shown in FIG. 4A, subpanels (c) and (d), provided a conformal skin contact to lower the skin-electrode contact impedance [10], increasing the effective contact area [11] and the skin-electrode interfacial capacitance [12].

In FIG. 4B, the study measured the skin-electrode contact impedance of two electrode types: serpentine-patterned (shown as 402) and nonpatterned rectangular electrodes (shown as 420). In FIG. 4B, subpanel (b), when compared with the rectangular electrode 420, the serpentine electrode 402 showed lower impedance density (p-value <0.001). The forearm is one of the parts that get much movement as it performs various activities in daily life. Especially in agriculture, industry, and military, various shocks can be applied to the arm due to the user's actions or external stimuli, which can damage the sensor device when attached to the forearm. Therefore, the study developed the electrode to enhance durability instead of maximizing flexibility and stretchability.

Compared to the electrode described in the previous studies [13], the electrode 402 in the study was enhanced with intersecting serpentine patterns for reliability. This showed the system's endurance, ensuring that the overall signal measurement remained stable and reliable, even when an external stimulus damaged part of an electrode. In previous studies [14], hydrogel-based electrodes demonstrated excellent performance in conformal skin contact and mitigating motion artifacts. However, hydrogels' low mechanical durability and temperature- or humidity-sensitive nature may lead to poor performance in real-life applications. On the contrary, the exemplary sensor device, consisting of a metal-based dry electrode with high electrical conductivity, mechanical durability, and resistance to environmental changes, can be practically used in various environments without performance degradation.

FIG. 4C shows the fabrication process of the sensor device of the exemplary system: (1) cutting the adhesive substrates (step 430), (2) attaching interconnectors and electrodes to the adhesive layer by putting the assembled circuit part into the gap (step 432), and (3) connecting a battery and encapsulation with elastomer (step 434). In step 434, a lithium polymer battery (3.7 V, 150 mAh) with a slide switch and a circular magnetic recharging port was connected to the power regulator. Except for the switch and charging port, the overall circuit was encapsulated and soft-packaged with an elastomer.

In FIG. 4D, the fabricated sensor device was bendable, stretchable, and twistable. The fabricated sensor device provided portable data acquisition without worrying about typical motion artifacts of multi-channel wearable electrodes with a separate data acquisition system [15]. In addition, flexibility of the fabricated sensor device ensured adaptation to body movements and changes, facilitating attachment to areas with frequent bending [16].

The fabricated sensor device of the exemplary system provided a small form factor, skin conformality, and mechanical reliability to ensure user comfort, enhanced signal with minimal noise, and consistency over multiple uses. Incorporating all components into a single flexible board eliminated the need for additional parts and wiring, creating a more compact and lightweight system. This method simplified the manufacturing process and bolstered the exemplary system's overall reliability. One benefit of using an all-in-one flexible board (shown in FIG. 4A, subpanel b) was its ability to maintain signal integrity by minimizing soldered joints, which helped applications deal with high-frequency signals or sensitive biopotential measurements, where maintaining the quality of the signal was importance. From a production standpoint, integrating all elements into one flexible board streamlines assembly, making manufacturing easier and more cost-effective. Furthermore, the flexibility of the flexible board ensures it fits comfortably against the skin, reducing pressure points and preventing skin irritation.

Mechanical characterization of the exemplary system. FIG. 5A shows the mechanical characterization and material properties of the exemplary system. The study used a finite element analysis tool (FEA) (e.g., Abaqus of Dassault Systèmes) to design a flexible and stretchable mechanical structure.

For validating the electro-mechanical reliability of fabricated sensor device, samples of forearm patches were mechanically bent using a motorized testing machine (ESM303, Mark-10) with a speed of 115 mm min⁻¹. For the cyclic bending test, the sample was repeatedly bent and unfolded at the same speed for 100 cycles (about 3.5 h). In addition, samples of serpentine electrodes were mechanically stretched using ESM303 with a speed of 15 mm min⁻¹. For the cyclic stretching test of the electrode, the samples were repeatedly stretched and relaxed at 15 mm min⁻¹ speed for 100 cycles (≈1 hour).

Continuous bending strain was applied when attaching the fabricated sensor device to the human's forearm. The average forearm circumference of adults may range from ≈23 to 33 cm for males and 20 to 30 cm for females [17]. Thus, in FIG. 5A, subpanel (a), the FEA results demonstrated the strain changes of the electrodes and interconnectors with a bending radius of 45 mm. The strain applied to the polyimide (PI) and copper layers was less than 1%. Additionally, the strain applied to the electrodes was less than 0.5%.

In addition, in FIG. 5A, subpanel (b), the electrode design can endure stretching up to 15% with less than 2% strain on the metal layer.

Based on the computational simulation results, the study conducted a set of experimental validation. In FIG. 5A, subpanel (c), the device showed negligible electrical resistance changes during the bending test (radius: 45 mm). The metal layer showed a resistance change of 4 mΩ, 0.16% of its original value.

A stretching test shown in FIG. 5A, subpanel (d) showed a negligible change in resistance with 1.1 mΩ, 0.11% of its original value.

A cyclic bending and stretching test shown in FIG. 5A, subpanel (e) further validated the device's mechanical stability with a negligible long-term change before and after the test, a decrease of 5 mΩ (0.2%) and a decrease of 1.5 mΩ (0.15%), respectively. These small resistance changes cannot affect the recording of electrophysiological signals [18].

FIG. 5B shows the measured electrical resistance of the interconnector and electrodes during continuous bending strain and stretching strain. Negligible resistance changes (3 mΩ; 0.12%) during continuous bending (shown in FIG. 5B, subpanel a) and negligible resistance changes (0.9 mΩ; 0.09%) during stretching (shown in FIG. 5B, subpanel b) for 30 min showed the signal stability provided by the SED.

Considering a continuous use case of the fabricated sensor device, breathability may be important because moisture can affect the adhesion and the quality of the measured signal [13], [14], [19]. Although a little sweat can increase the signal-to-noise ratio [19b], excessive sweating may cause device delamination from the skin [20]. Strong adhesion may be essential to maintain consistent skin-electrode contact impedance [21]. FIG. 5C shows the measured moisture vapor transmission rate (MVTR) values for four adhesive substrates (e.g., 9907T+S, 9907T, 2476P, and 2480). In this experiment, glass bottles containing 20 g of water were prepared, and the openings were covered with adhesive substrates. Four adhesive substrates were selected as candidates based on the literature survey [13], [16c], [19b]. The MVTR was calculated by measuring water evaporation weight through each substrate for 24 hours under room temperature conditions (e.g., 24° C.). As a result, the 9907T tape showed the highest MVTR (55.4877 g m⁻² h) when compared to other adhesive tapes.

Material properties of the exemplary system. The study prepared three test samples of four different adhesive substrates (9907T+S, 9907T, 2476P, and 2480) in a 3.81×10.16 cm (1.5×4-inch) space. “9907T+S” indicates the adhesive substrate that the Silbione (e.g., A-4717, Factor II Inc.) was coated on the 9907T. To measure the peeling strength of each sample, each sample was attached to the forearm after properly cleaning the skin using an alcohol swipe. Each sample was peeled vertically with a motorized force tester (e.g., ESM303, Mark-10) at a 30 mm min⁻¹ speed. The force tester recorded adhesion force data during the test until full detachment. To quantify the peeling energy, the area under the force-distance curves was calculated using the “trapz” function of MATLAB and divided by the substrate area (3.81×8 cm). To measure the peeling energy of adhesive substrates on the wet skin, 2 mL of water was dropped on the skin before attaching samples to the skin.

FIG. 5D shows an experiment measuring the peeling force of the four substrates (e.g., 9907T+S, 9907T, 2476P, 2480) from the skin in both dry and wet skin conditions.

FIG. 5E shows the measured peeling force, peeling energy ratio, and peeling energy values of the substrates from the skin in the experiment shown in FIG. 5D. In FIG. 5D, subpanel (a), the 9907T tape showed the highest peeling energy ratio among the four candidates. In FIG. 5D, subpanels (b) and (c), the other three substrates had higher peeling energy in dry skin conditions. However, the adhesion was not maintained before the water was dropped on the skin. Considering both MVTR and peeling energy results, the 9907T tape was selected as the adhesive substrate to integrate the fabricated sensor device.

FIG. 5F shows the skin condition while wearing the fabricated sensor device for 8 hours, and no side effects were observed, such as skin irritation and redness. This result was likely due to the interaction between wearing the fabricated sensor device using adhesion without additional pressure and good breathability.

Performance validation of the exemplary system. FIG. 5G shows the fabricated sensor device (subpanel a) and a commercial armband-type device (e.g., Myo) (subpanel b). Both devices were mounted to the forearm for performance comparison and validation. The difference was the weight and form factor. The patch-type fabricated sensor device made intimate contact with the skin without additional fixtures, while the rigid and heavy armband required a tightening spring to secure the contact of rigid metal electrodes to the skin, causing discomfort and motion limits.

FIG. 5H shows a program that recorded EMG signals and presented hand gesture images. FIG. 5H, subpanel (a) shows the program interface demonstrating EMG signals from various channels and an image of a hand gesture. FIG. 5H, subpanel (b) shows the average and standard deviation of EMG signals measured from eight channels using ten hand gestures. After 3 seconds of resting with an idle gesture, a subject followed the instructions from the gesture detection program for 3 seconds. In the SNR calculation, the signal from −3 to −1 seconds was used as noise, and this signal from 1 to 3 seconds was used as the gesture signal. The fabricated sensor device and the commercial device cannot be sat in the same position on the arm because the electrode sizes and spacing between the pair electrodes of the two systems were all different. However, the EMG signals generated by activating specific forearm muscles can be conducted to the surroundings [22].

FIG. 5I shows the EMG signal values measured by the fabricated sensor device and the commercial device (e.g., Myo). In FIG. 5I, the EMG signals recorded by the two devices showed similar patterns. Therefore, the study confirmed that these devices sat near the same muscle groups on the forearm.

FIGS. 5J and 5K shows the histogram of the calculated SNR values under dry and wet skin conditions. The histogram distribution of SNR from the two devices compared the signal acquisition performance for various muscle groups and gestures. In FIG. 5J, the SNR values of the fabricated sensor device and the commercial device (e.g., Myo) were 16.52±11.24 and 11.85±9.81 dB, respectively. The SNR of the fabricated sensor device was significantly higher than that of the commercial device (p-value <0.001). In FIG. 5K, subpanel (a), the SNR of the fabricated sensor device was even higher than that of the commercial device under the wet skin condition. The enhanced signal quality of the fabricated sensor device came from skin conformality and natural motion detection by the lightweight, flexible device on the skin [23]. Overall, the fabricated sensor device had eight channels to cover multiple muscles for more accurate differentiation of different gestures.

FIG. 5L shows the representative images and corresponding EMG signals from ten hand gestures made by a subject wearing the fabricated sensor device.

Signal processing and Data Classification methods. The study developed a classifier (i.e., classification module) that required short training time by combining feature extraction and machine-learning methods to recognize hand/wrist gestures. FIG. 5M shows the classification method and the evaluation of the classifier of the exemplary system and other state-of-the-art classifiers.

FIG. 5M, subpanel (a) shows the flow chart of the classification procedure. First, EMG signals recorded at all eight channels with a sampling rate of 2000 Hz were filtered using fourth-order Butter-worth band-pass filters to remove 60 Hz power line noise and its harmonic frequency components. The cutoff frequencies of each filter were set to ±8 Hz of the target. Then, the signals were further processed using a fourth-order Butterworth bandpass filter with 20 and 450 Hz cutoff frequencies [22], [24] The filtered EMG signals were divided into short segments using a 300-ms sliding window (600 samples) with 96% overlap. For each segment, a spatial covariance matrix (SCM) was extracted. The SCM can be calculated per Equation 1.

$$SCM = {XX}^{T} / ( N - 1 ) \qquad ( Eq . l )$$

In Equation 1, X∈ [symbol] ^{C×N} is EMG signals, with C is the number of channels and N is the number of time samples.

The SCM is a symmetric and positive-definite matrix and can be regarded as a point on Riemannian manifolds. Then, the Riemannian average matrices were computed using SCMs, and the average matrices were mapped onto the Riemannian tangent space. The SCMs mapped onto the tangent space formed by the average matrices were used as the Riemannian feature. This tangent space mapping process allowed the matrices to be vectorized and dealt with like Euclidian objects. In addition, this mapping processing allowed the use of advanced classifiers available in Euclidean space within the Riemannian space [25]. All signal preprocessing and Riemannian feature extraction were performed using Python 3.8 and pyRiemann toolbox.

FIG. 5M, subpanel (b) shows the representation of our Riemannian features using t-distributed stochastic neighbor embedding visualization [26]. All gestures were well clustered. Based on these well-distributed Riemannian features extracted from EMG signals, ten hand/wrist gestures were classified using the ML method. A dataset consisted of three trials, and each trial consisted of ten hand/wrist gestures. In each cross-validation, one trial was selected as the test dataset, and the remaining two trials were used as the training dataset. The Riemannian average matrices were computed using only the training dataset. Classification accuracy was calculated for each dataset, and a total of 15 datasets were used to compare the classification performance of 10 classifiers.

As summarized in FIG. 5M, subpanel (c), the support-vector machine (SVM) showed the highest classification accuracy of 96.08±3.15%, and the confusion matrix of the classification outcome resulted in FIG. 5M, subpanel (d).

FIG. 5N shows the hyperparameters of SVM optimized using the grid search method for total datasets, and the classification accuracy of individual datasets. SVM's optimized cost and gamma values were 1.09 and 1/72, respectively. Among ten gestures, the classification accuracy of the “spread” gesture was lower than that of other gestures, with a precision of 89.6%. This was because it was difficult to accurately perform the “spread” gesture. The “spread” gesture was misclassified as “right” and “index” gestures.

Spreading the hand and bending the wrist were conducted by activating the extensor carpi ulnaris, extensor carpi radialis longus, and extensor carpi radialis brevis muscles. Excessive and forceful hand spreading and bending the wrist outward can produce a similar EMG signal when making a spread gesture. Similarly, in both “spread” and “index,” the middle, ring, and little finger were stretched commonly. In conclusion, the intricacies of overlapping muscle activations and EMG signal similarities were recognized as areas for enhancement. The study acknowledged this complexity and developed the exemplary classifier as a next step, enhancing the exemplary system's reliability and robustness for better applications.

The exemplary classifier registered a performance that was slightly lower (by ≈1%) than some state-of-the-art technologies utilizing deep learning methods for gesture recognition [27]. In the study, the objective was to create a gesture recognition system that can be instantly usable upon wearing the fabricated sensor device. Therefore, some deep learning methods were unsuitable due to their extensive data and longer training time requirements. The study optimized gesture recognition performance by integrating a Riemannian feature with SVM, requiring only a 1-minute training period. This was an improvement over the conventional methods that required tens or hundreds of sample data for each gesture [27]. The minimal data requirement and reduced computational load of the exemplary classifier enhanced its practicality for real-time applications and seamless integration into wearable and portable devices. Furthermore, SVM was suitable for real-time classification due to less computational load and can be easily integrated into wearable and portable devices.

For the practical use of interfaces, minimizing the training time and the amount of training data required was important in maintaining performance with repeated use [28]. The study tested how long the classification accuracy was maintained with just one-time training. For this long-term usability test, the study conducted an additional experiment in which ten gestures were repeated 11 times with the fabricated sensor device attached or wearing a commercial device using the recording program shown in FIG. 5H, subpanel (a).

Classifier Results. The first trial was used as the training data set for training the machine-learning classifier, and the remaining ten trials were used as the test dataset. FIG. 5O shows the recognition accuracy of the fabricated sensor device and the commercial device (e.g., Myo).

As summarized in FIG. 5O, the classification accuracies of the fabricated device and the commercial Myo were 95.11±9.81% and 89.71±6.08%, respectively. The fabricated sensor device performed better than the commercial one regarding long-term usability (p-value=0.0977). About 50 hand gestures were classified with 100% accuracy. However, starting from the sixth trial, a subject expressed muscle fatigue in repeating the same gestures. The system may perform better practically by implementing a classification method that considers fatigue. Unlike the fabricated sensor device, the accuracy of the commercial device continued to decrease even from the first trial without muscle fatigue. Furthermore, from the sixth trial to the ninth trial, rapid fluctuation in performance occurred. Addressing these performance inconsistencies may be imperative for the tangible real-world application of gesture classification. As a method for preventing performance reduction caused by muscle fatigue and rapid changes in performance, domain adaptation techniques can be used. This method can adapt features and classifiers when data distributions differed [29]. Because muscle fatigue and inconsistent signal quality may cause changes in EMG signal patterns, that is, changes in data distribution, utilizing domain adaptation techniques can enhance the system's robustness, ensuring consistent performance despite muscle fatigue and signal variations in real-life applications.

Continuous Drone Control Demonstration. FIG. 5P shows the performance of the exemplary system configured for wireless, real-time, continuous control of a first-person-view (FPV) drone. The augmented reality (AR) interface, built on the exemplary system, enhanced productivity and collaboration within screen-based working environments. AR can transform complex data into manipulable 3D graphs or charts, offering intuitive insights directly through the screen [30]. AR also provided accessibility, molding screen content to cater to the specific needs and preferences of individuals with disabilities [31].

FIG. 5P, subpanel (a) shows the AR interface 326 configured for the exemplary system, wherein a subject wore the fabricated sensor device 304 and AR glasses 302 (e.g., Nreal Light) with eight-channel EMG signals 314 (shown as 314′) and an example AR virtual screen 326. Using the “fist” gesture, a subject can open a virtual screen with a mouse click. Then, the window's position can be adjusted as needed. There were ten different gestures 502 used to control the AR interface 326. Based on the developed AR interface 326, the study utilized the fabricated sensor device 304 to control an FPV drone with EMG signals via drone interface 328.

Using goggles or headsets that confine the user to the screen while operating a machine, such as a drone, can immerse the user in a screen and the operation of the machine. However, this immersion can be a disadvantage when operating machines in industrial or hazardous environments where real-world interaction and awareness may be essential, so it may be appropriate to use AR that can be aware of their surroundings. AR glasses 302 can guide the operator by displaying video and other telemetry data 330, such as altitude, speed, and battery status, directly in the drone pilots' field of view in real-time.

FIG. 5P, subpanel (b) summarizes an example of controlling the drone with a camera for sending a video feed to external devices. Through the interfaces 326 and 328, a subject in subpanel (b) controlled the drone using ten different gestures 502, including take-off/land (shown as 1), moving left (shown as 3), right (shown as 4), forward (shown as 5), backward (shown as 2), up (shown as 8), down (shown as 9), left turn (shown as 6), right turn (shown as 7), and hovering (shown as 10). By synergizing AR, FPV drones, and the fabricated sensor device, the study validated the proof of concept and underscored the system's expandability, illustrating its potential to provide user interaction and control in diverse industrial applications without the need for additional hand-held displays or controllers.

### Discussion

Augmented reality (AR) is a computer graphics technology that establishes a blend of the real and virtual worlds. By integrating virtual elements and information into physical surroundings, over 83 million users in the United States are projected to experience AR monthly by the end of 2023 [1], interacting with diverse, layered digital enhancements over their real-world surroundings. With a predicted market value of over $50 billion by 2024 [1], AR adoption is flooding various sectors, including education, healthcare, entertainment, and retail. This trend shows the capability of AR to reshape societal interactions and human experiences. The embracement of AR, however, has encountered several challenges, primarily associated with its control interface usability. Reliant on hand-held controllers [2], AR often imposes restrictive hand movements, making its usage limited and less user-friendly. Despite the technological advancement in AR, the AR interfaces often entail using obtrusive hand-held controllers, limiting usability due to restrictive hand movements. This limitation is also prominent in camera-based hand gesture recognition technologies [3], as in the case of AR headsets like the Microsoft HoloLens, and Oculus Quest, which demand constant visibility of the user's hands for gesture recognition, rendering them problematic for everyday use. This necessity, when paired with the technology's vulnerability to different lighting conditions, further diminishes the utility of AR interfaces. A more user-friendly, fully adaptable, and readily deployable AR solution that can overcome limitations and constraints in the current technology is needed.

Recent advances in real-time analysis systems of electromyography (EMG), an electrical signal produced during muscle activity, and in conjunction with advancements in machine learning (ML) may enhance the usability of AR. Since EMG contains insights into muscle activation and human muscle intention [4], wearable biosensors introduce a precise control system ensuring the precise classification of hand gestures. The forearm, an area with muscles involved in hand movements, has been found advantageous for signal acquisition, improving classification accuracy. Different gestures involve the activation of different muscles in the forearm. For example, flexing the wrist involves primarily the flexor muscles, while extending the wrist involves the extensor muscle. In addition, making a first involves activating various forearm muscles working in harmony to flex the fingers and wrist. The activation and harmony of specific muscles will vary depending on the gesture, leading to distinct EMG signal patterns. Even in cases of amputees, EMG can be recorded from the remaining muscles in the forearm [5]. To effectively classify hand gestures, measuring EMG from distinct specific muscles is necessary for the classification process. Soft and skin-like conformal sensors that can measure these muscle signals provide an accurate system for classifying hand gestures [6], enabling a more sophisticated interaction with the AR environment.

In contrast to computer vision-based systems, decoding human intention with EMG overcomes visual limitations. It allows for a more accurate interpretation of gestures, even in environments with varying light conditions. Unlike the light-dependent nature of computer vision systems, EMG is immune to light fluctuations, making it a robust tool that stands unrivaled in its ability to detect and classify hand movements, reinforcing its advantage in gesture detection systems. Conversely, EMG signals have high individual variability caused by differences in physiological factors such as skin condition, muscle/fat mass, and structure of the neuromuscular system. Therefore, in terms of identifying hand/finger gestures, it is difficult to generalize the EMG signal pattern according to gesture and to apply the latest and state-of-the-art technologies that require a lot of data for training, such as deep learning methods.

The study introduced an innovative solution combining EMG-based soft bioelectronics with AR technology. The study explored four primary areas: (1) the development and validation of a soft, wireless forearm sensor device, emphasizing the flexibility and stretchability of versatile wearable applications; (2) the implementation of EMG-based electronics to enable camera-less hand gesture recognition, overcoming limitations of AR hand tracking systems; (3) use of ML techniques based on Riemannian feature that requires only short training of less than 1 min for real-time hand gesture classification with an impressive average accuracy of 96.08%; and (4) establishing an AR application platform using the soft wearable device for both screen-based working environment and complex teleoperation. Integrating these technologies into wearable devices may develop new strides in bioelectronic devices and AR applications, offering a more intuitive, comfortable, and immersive user experience.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] V. A. Vieira, D. N. Rafael, R. Agnihotri, J. Bus. Res. 2022, 151, 170.
[2] Y.-J. Huang, K.-Y. Liu, S.-S. Lee, I.-C. Yeh, Int. J. Human-Computer Interact. 2021, 37, 169.
[3] a) W. Fang, J. Hong, J. Manuf. Syst. 2022, 65, 169; b) R. Wen, W.-L. Tay, B. P. Nguyen, C.-B. Chng, C.-K. Chui, Computer Methods Progr Biomed 2014, 116, 68.
[4] W.-T. Shi, Z.-J. Lyu, S.-T. Tang, T.-L. Chia, C.-Y. Yang, Biocybern Biomed Eng 2018, 38, 126.
[5] F. Riillo, L. R. Quitadamo, F. Cavrini, E. Gruppioni, C. A. Pinto, N. C. Pastò, L. Sbernini, L. Albero, G. Saggio, Biom Signal Proc Control 2014, 14, 117.
[6] a) J. Tropp, J. Rivnay, J. Mater. Chem. C 2021, 9, 13543; b) J. Kim, I. Jeerapan, J. R. Sempionatto, A. Barfidokht, R. K. Mishra, A. S. Campbell, L. J. Hubble, J. Wang, Acc. Chem. Res. 2018, 51, 2820.
[7] D. Mourtzis, J. Angelopoulos, N. Panopoulos, IFAC-PapersOnLine 2022, 55, 983.
[8] C. Cambra, J. R. Díaz, J. Lloret, presented at Ad-hoc Networks and Wireless: ADHOC-NOW 2014 International Workshops, ETSD, MARSS, MWaoN, SecAN, SSPA, and WiSARN, Springer, Berlin Heidelberg, 2014 p. 2015.
[9] P.-J. Bristeau, F. Callou, D. Vissière, N. Petit, IFAC Proc Vol 2011, 44, 1477.
[10] S. P. Lacour, J. Jones, S. Wagner, T. Li, Z. Suo, Proc of the IEEE, IEEE, New York 2005.
[11] G. Schwartz, B. C.-K. Tee, J. Mei, A. L. Appleton, D. H. Kim, H. Wang, Z. Bao, Nat. Commun. 2013, 4, 1859.
[12] S. Wang, N. Liu, J. Su, L. Li, F. Long, Z. Zou, X. Jiang, Y. Gao, ACS Nano 2017, 11, 2066.
[13] S. Kwon, H. S. Kim, K. Kwon, H. Kim, Y. S. Kim, S. H. Lee, Y.-T. Kwon, J.-W. Jeong, L. M. Trotti, A. Duarte, Sci. Adv. 2023, 9, eadg9671.
[14] H. Wu, G. Yang, K. Zhu, S. Liu, W. Guo, Z. Jiang, Z. Li, Adv Sci 2021, 8, 2001938; b) G. Yang, K. Zhu, W. Guo, D. Wu, X. Quan, X. Huang, S. Liu, Y. Li, H. Fang, Y. Qiu, Adv. Funct. Mater. 2022, 32, 2200457.
[15] Y. Wang, H. Haick, S. Guo, C. Wang, S. Lee, T. Yokota, T. Someya, Chem. Soc. Rev. 2022, 51, 3759; b) H. R. Lim, H. S. Kim, R. Qazi, Y. T. Kwon, J. W. Jeong, W. H. Yeo, Adv. Mater. 2020, 32, 1901924.
[16] C. Wang, C. Wang, Z. Huang, S. Xu, Adv. Mater. 2018, 30, 1801368; b) Y. Li, A. F. Rodríguez-Serrano, S. Y. Yeung, I.-M. Hsing, Adv. Mater. Technol. 2022, 7, 2101435; c) J. Kim, P. Kantharaju, H. Yi, M. Jacobson, H. Jeong, H. Kim, J. Lee, J. Matthews, N. Zavanelli, H. Kim, npj Flex. Electron. 2023, 7, 3.
[17] R. Anakwe, J. Huntley, J. E. McEachan, J. Hand Sur. 2007, 32, 203.
[18] I. Ahmad, F. Ansari, U. Dey, Int. J. Eng. Sci. Technol. 2012, 4, 530.
[19] H. Zhang, R. He, H. Liu, Y. Niu, Z. Li, F. Han, J. Li, X. Zhang, F. Xu, Sens. Actuators, A 2021, 322, 112611; b) Y.-S. Kim, J. Kim, R. Chicas, N. Xiuhtecutli, J. Matthews, N. Zavanelli, S. Kwon, S. H. Lee, V. S. Hertzberg, W.-H. Yeo, Adv. Healthcare Mater. 2022, 11, 2200170.
[20] L. Kalevo, T. Miettinen, A. Leino, S. Kainulainen, H. Korkalainen, K. Myllymaa, J. Töyras, T. Leppänen, T. Laitinen, S. Myllymaa, IEEE Access 2020, 8, 50934.
[21] Y. Jiang, X. Zhang, W. Zhang, M. Wang, L. Yan, K. Wang, L. Han, X. Lu, ACS Nano 2022, 16, 8662; b) S. Baik, H. J. Lee, D. W. Kim, J. W. Kim, Y. Lee, C. Pang, Adv. Mater. 2019, 31, 1803309.
[22] H. Kim, D. Zhang, L. Kim, C.-H. Im, Expert Syst. Appl. 2022, 188, 116101.
[23] H. Kim, Y.-S. Kim, M. Mahmood, S. Kwon, F. Epps, Y. S. Rim, W.-H. Yeo, Biosens. Bioelectron. 2021, 173, 112764; b) D. Gao, K. Parida, P. S. Lee, Adv. Funct. Mater. 2020, 30, 1907184; c) S. Chen, K. Hou, T. Li, X. Wu, Z. Wang, L. Wei, W. L. Leong, Adv. Mater. Technol. 2023, 8, 2200611.
[24] H.-S. Cha, W.-D. Chang, C.-H. Im, Virt. Real. 2022, 26, 1047; b) H.-S. Cha, S.-J. Choi, C.-H. Im, IEEE Access 2020, 8, 62065.
[25] A. Barachant, S. Bonnet, M. Congedo, C. Jutten, presented at Int. Conf. on Latent Variable Analysis and Signal Separation, Springer, Berlin, Heidelberg, 2010; b) A. Barachant, S. Bonnet, M. Congedo, C. Jutten, IEEsE Trans. Biomed. Eng. 2011, 59, 920; c) A. Barachant, S. Bonnet, M. Congedo, C. Jutten, Neurocomputing 2013, 112, 172; d) M. Congedo, A. Barachant, R. Bhatia, Brain-Computer Interfaces 2017, 4, 155.
[26] L. Van der Maaten, G. Hinton, J. Mach. Learn. Res. 2008, 9, 2579.
[27] H. Fang, L. Wang, Z. Fu, L. Xu, W. Guo, J. Huang, Z. L. Wang, H. Wu, Adv. Sci. 2023, 10, 2205960; b) F. Wen, Z. Sun, T. He, Q. Shi, M. Zhu, Z. Zhang, L. Li, T. Zhang, C. Lee, Adv. Sci. 2020, 7, 2000261.
[18] L. Bottou, in Proceedings of COMPSTAT'2010, Springer, 2010, pp. 177-186; b) P. Domingos, Commun. ACM 2012, 55, 78.
[29] H.-S. Cha, C.-H. Im, Virt. Real. 2023, 27, 1685.
[30] H. Kim, Y.-T. Kwon, H.-R. Lim, J.-H. Kim, Y.-S. Kim, W.-H. Yeo, Adv. Funct. Mater. 2021, 31, 2005692.
[31] A. J. Lungu, W. Swinkels, L. Claesen, P. Tu, J. Egger, X. Chen, Exp. Rev. Med. Devices 2021, 18, 47; b) L. Bautista, F. Maradei, G. Pedraza, Int J Interact. Design Manufact. (IJIDeM) 2020, 14, 1031.
[32] H. W. Lilliefors, J. Am. Stat. Assoc. 1967, 62, 399; b) H. Kim, J. Ha, W.-D. Chang, W. Park, L. Kim, C.-H. Im, Sensors 2018, 18, 102.

What is claimed:

1. A system comprising:
an electrode array assembly comprising an electrode array and an adhesive substrate, configured to attach to a forearm of a person, wherein the electrode array is formed by one or more flexible, conformable electrodes; and
a controller having:
a processor; and
a memory having instructions stored thereon, wherein execution of the instructions causes the processor to:
receive, by the processor, measured electromyographical (EMG) signals from the electrode array assembly at the forearm while the person is making one or more hand gestures;
determine, via a trained ML model, a classification value using the measured EMG signals, wherein the classification value has a correspondence to a pre-defined hand gesture among a plurality of hand gestures, wherein the trained ML model was trained using a plurality of EMG signals acquired at a set of forearms and labels corresponding to hand gestures made by a set of people; and
output the classification value, wherein the classification value is subsequently employed for controls or analysis.

2. The system of claim 1, wherein the classification value is associated with (i) a hand gesture defined by a combination of finger and wrist positions and orientation or (ii) a hand gesture defined by one or more finger positions and configurations.

3. The system of claim 1, wherein the classification value is employed for a control system, wherein the control system is configured to transmit real-time video stream to an augmented reality device.

4. The system of claim 1, wherein the electrode array is embedded into the adhesive substrate.

5. The system of claim 4, wherein the controller is disposed on a surface of the adhesive substrate of the electrode array assembly.

6. The system of claim 1, wherein the one or more flexible, conformable electrodes are formed of (i) a serpentine-patterned structure at a first end and (ii) a terminal at a second end.

7. The system of claim 6, wherein each serpentine-patterned structure of the one or more flexible, conformable electrodes is formed of a first layer comprising a metal and a second layer comprising a polyimide.

8. The system of claim 1, wherein the classification value is employed as an actuatable control output to a control system.

9. The system of claim 1, wherein the classification value is employed for an analysis system.

10. The system of claim 1, wherein the classification value is employed as a prompt input for a computer operating system.

11. A method comprising:
receiving, by a processor, measured electromyographical (EMG) signals from an electrode array assembly at a forearm while a person is making one or more hand gestures;
determining, via a trained ML model, a classification value using the measured EMG signals, wherein the classification value has a correspondence to a pre-defined hand gesture among a plurality of hand gestures, wherein the trained ML model was trained using a plurality of EMG signals acquired at a set of forearms and labels corresponding to hand gestures made by a set of people; and
outputting the classification value, wherein the classification value is subsequently employed for controls or analysis.

12. The method of claim 11, wherein the electrode array assembly comprises an electrode array and an adhesive substrate, configured to attach to the forearm of the person, wherein the electrode array is formed by one or more flexible, conformable electrodes.

13. The method of claim 12, wherein the electrode array is embedded into the adhesive substrate.

14. The method of claim 12, wherein the one or more flexible, conformable electrodes are formed of (i) a serpentine-patterned structure at a first end and (ii) a terminal at a second end.

15. The method of claim 14, wherein each serpentine-patterned structure of the one or more flexible, conformable electrodes is formed of a first layer comprising a metal and a second layer comprising a polyimide.

16. The method of claim 11, wherein the classification value is associated with (i) a hand gesture defined by a combination of finger and wrist positions and orientation or (ii) a hand gesture defined by one or more finger positions and configurations.

17. The method of claim 11, wherein the classification value is employed for a control system, wherein the control system is configured to transmit real-time video stream to an augmented reality device.

18. The method of claim 11, wherein the classification value is employed as an actuatable control output to a control system.

19. The method of claim 11, wherein the classification value is employed for an analysis system.

20. A non-transitory computer-readable medium having instructions stored thereon, wherein execution of the instructions by a processor causes the processor to:
receive, by the processor, measured electromyographical (EMG) signals from an electrode array assembly at a forearm while a person is making one or more hand gestures;
determine, via a trained ML model, a classification value using the measured EMG signals, wherein the classification value has a correspondence to a pre-defined hand gesture among a plurality of hand gestures, wherein the trained ML model was trained using a plurality of EMG signals acquired at a set of forearms and labels corresponding to hand gestures made by a set of people; and
output the classification value, wherein the classification value is subsequently employed for controls or analysis.
